(19) United States
(12) Patent Application Publication
(10) Pub. No.: US 2009/0089680 A1
(43) Pub. Date: Apr. 2, 2009

(54) ALIASING UNIFORM RESOURCE LOCATIONS WITHIN A BROWSER

(76) Inventors: John Michael Garrison, Austin, TX (US); Michael S. McKay, Round Rock, TX (US)

Correspondence Address: IBM CORP (YA);C/O YEE & ASSOCIATES PC, P.O. BOX 802333, DALLAS, TX, 75380, US

(21) Appl. No.: 11/862,953

(22) Filed: Sep. 27, 2007

(51) Int. Cl. G06F 3/00; G06F 15/16

(52) U.S. Cl. 715/739; 709/245

(57) ABSTRACT

A computer implemented method, data processing system, and a computer program product are provided for resolving uniform resource locator addresses. A first uniform resource locator address is input from a user. The first uniform resource locator address is identified within a database list of uniform resource locator addresses. Each of the list of uniform resource locator addresses corresponds to a second uniform resource locator address contained in the database. Responsive to identifying the first uniform resource locator address with the list of uniform resource locator addresses, information for the corresponding second uniform resource locator address is displayed.

### BACKGROUND OF THE INVENTION

1. Field of the Invention

The present invention relates generally to a computer implemented method, data processing system, and a computer program product resolving uniform resource locator addresses within a browser. More specifically, the present invention relates to a computer implemented method, data processing system, and a computer program product for resolving uniform resource locator addresses within a browser using browser-defined aliases.

2. Description of the Related Art

When providing live or recorded browser-based demonstrations of presentations, it is often necessary to reference uniform resource locator addresses for systems that are not intended to be published to a wider or external audience. One example is at a customer site, a presenter is connected to the corporate network via a virtual private network and is accessing servers on the corporate network. Security or privacy reasons may be present for not exposing these host names and ports to the audience.

In another example that take place within an enterprise, the presenter does not want the wider audience to know the hostname/port for the demo system because the system is still being used for development or test purposes. The presenter would prefer to keep the server name “unlisted.”

In yet another example, the presenter would prefer to tailor the universal resource locators to the audience—maybe use acme.com when presenting to ACME Company, for example.

In each of the above illustrative examples, creating domain name system aliases is inconvenient in most cases. Also, creating aliases in the host's files does not help with universal resource locator references imbedded in a page. Thus, there is needed a method to locally create aliases and resolve universal resource locator addresses that do not compromise an enterprise's security by releasing sensitive internal universal resource locator names and addresses.

### SUMMARY OF THE INVENTION

A computer implemented method, data processing system, and a computer program product are provided for resolving uniform resource locator addresses. A first uniform resource locator address is input from a user. The first uniform resource locator address is identified within a database list of uniform resource locator addresses. Each uniform resource locator addresses in the database list corresponds to a second uniform resource locator address contained in the database. Responsive to identifying the first uniform resource locator address with the list of uniform resource locator addresses, information for the corresponding second uniform resource locator address is displayed.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of illustrative embodiments when read in conjunction with the accompanying drawings, wherein:

FIG. 1 depicts a pictorial representation of a network of data processing systems in which illustrative embodiments may be implemented;

FIG. 2 is a block diagram of a data processing system shown in which illustrative embodiments may be implemented;

FIG. 3A is a diagram showing the data flow between the various hardware and software components shown according to illustrative embodiments;

FIG. 3B is a diagram showing the data flow between the various hardware and software components shown according to illustrative embodiments;

FIG. 4 is a block diagram illustrating processing steps shown according to illustrative embodiments; and

FIG. 5 is a block diagram illustrating processing steps shown according to illustrative embodiments.

### DETAILED DESCRIPTION OF THE PREFERRED EMBODIMENT

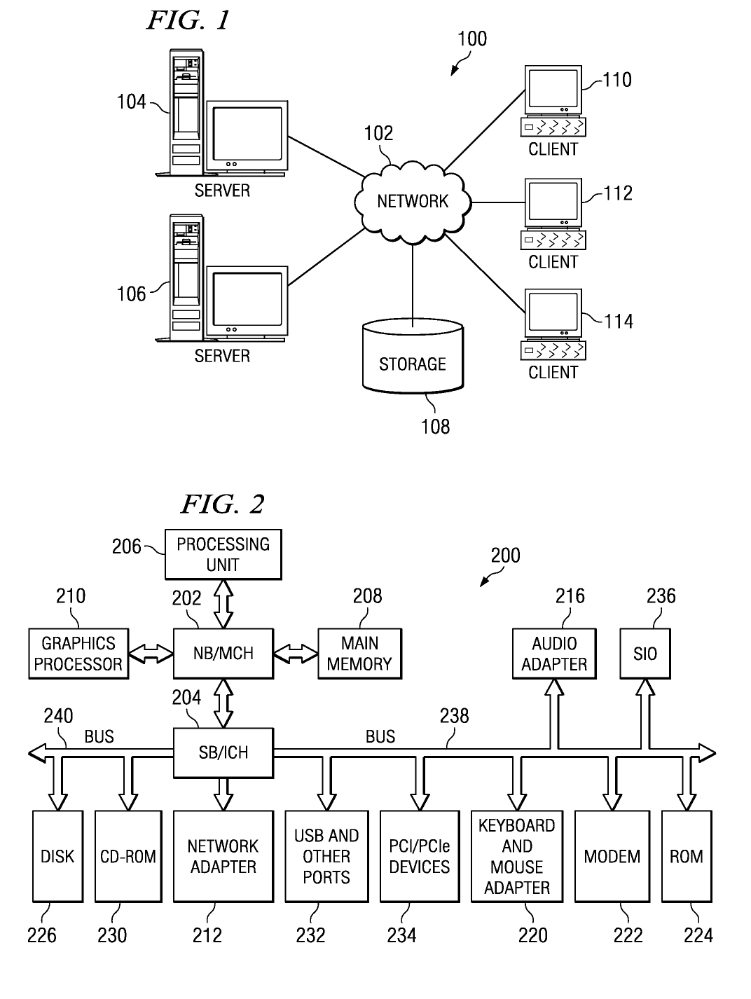

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™ (Microsoft and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

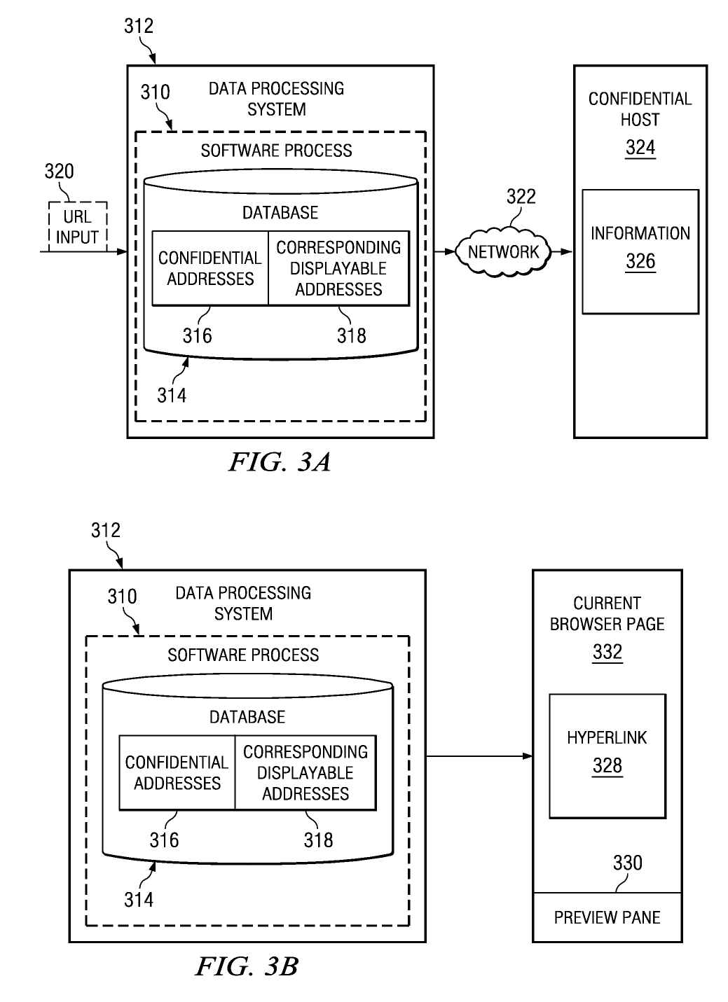

Referring now to FIG. 3A, a diagram showing the data flow between the various hardware and software components is shown according to illustrative embodiments. Software process 310 executes on data processing system 312. Data processing system 312 can be clients 110-114 of FIG. 1.

Software process 310 is a software process capable of displaying web pages and information stored at universal resource locator addresses. Software process 310 can be a commercially available Internet browser, such as, for example, Microsoft Internet Explorer®, Mozilla® Firefox®, and Netscape Navigator. Software process 310 may also be any proprietary software capable of displaying web pages and information stored at universal resource locator addresses. Similarly, software process 310 can be ancillary software that works in conjunction with a software process capable of displaying web pages and information stored at a universal resource locator addresses.

Software process 310 contains database 314. Database 314 can be a lookup table, or other data structure capable of resolving a user input into a secondary data address. Database 314 contains confidential addresses 316 and displayable addresses 318 corresponding to confidential addresses 316. Confidential addresses 316 are those universal resource locators for systems not really intended to be published to a wide or external audience for which a user may wish to use an alias address. Displayable addresses 318 are alias addresses that point to the same universal resource locator location as do corresponding confidential addresses 316. However, displayable addresses will display a spurious universal resource locator address to the user.

A user enters universal resource locator input 320 into software process 310. Responsive to receiving universal resource locator input 320, software process 310 compares universal resource locator input 320 to displayable addresses 318. Software process 310 is seeking to determine whether the user who is inputting universal resource locator input 320 desires to display an alternate universal resource locator address.

Responsive to identifying universal resource locator input 320 as one of displayable addresses 318, software process 310 recalls the corresponding one of the confidential addresses 316. Software process 310 connects through the network 322 following the routing information of confidential address to confidential host 324. Software process 318 retrieves information 326 from confidential host 324 and displays to the user the data stored at a corresponding one of confidential addresses 316. However, instead of displaying routing and address information of the confidential address 316, software process 310 displays the spurious routing and address information of the displayable address 318.

Referring now to FIG. 3B, a diagram showing the data flow between the various hardware and software components is shown according to illustrative embodiments. The various software components and hardware components in FIG. 3B are identical to FIG. 3A.

Software process 310 displays current browser page 327. Current browser page 326 includes hyperlink 328. Hyperlink 328 is a reference or navigation element within current browser page 327 that points to another section of current browser page 327, another document, or a specified section of another document. When hyperlink 328 is selected, the referred to information is retrieved to the user by software process 310.

Current browser page is provided with a preview pane 330. When the user selects, or pre-selects hyperlink 328, routing and address information of hyperlink 328 is displayed within preview pane 330.

Responsive to a user selecting or pre-selecting hyperlink 328, software process 310 compares hyperlink 328 to confidential addresses 316. Software process 310 is seeking to determine whether hyperlink 328 is identical to one of confidential addresses 316. That is, software process 310 determines whether hyperlink 328 points to a universal resource locator for systems not intended to be published to a wide or external audience.

Responsive to identifying hyperlink 328 as one of confidential addresses 316, software process 310 recalls the corresponding one of displayable addresses 318. Software process 310 then displays the spurious routing and address information for the corresponding one of displayable addresses 318 in preview pane 330.

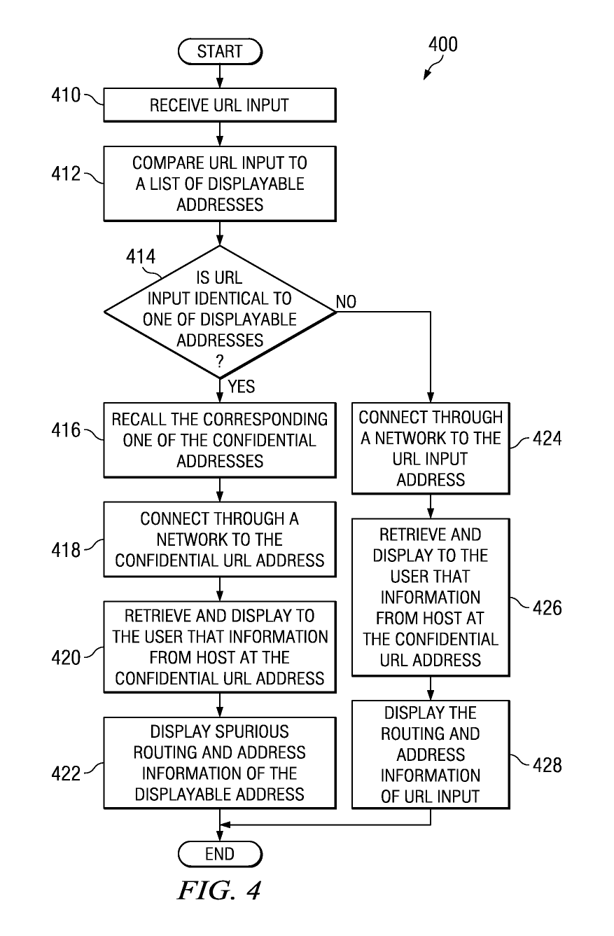

Referring now to FIG. 4, a block diagram is shown illustrating processing steps, according to illustrative embodiments. Process 400 is a software process, such as software process 310 of FIG. 3, executed on a data processing system, such as data processing system 310 of FIG. 3.

Process 400 begins by receiving a universal resource locator input (step 410). The universal resource locator input is received from a user and directs process 400 to the appropriate address. Universal resource locator input can be received by, but not limited by, a hyperlink selection from an active document, a hyperlink selection from a history of previously active documents, a hyperlink selection from an e-mail, and a manual entry, such as a keystroke entry, of the universal resource locator address.

Responsive to receiving universal resource locator input, process 400 compares the universal resource locator input to a list of displayable addresses (step 412). Displayable addresses are stored in a database, such as database 314 of FIG. 3, and correspond to confidential addresses, such as confidential addresses 316 of FIG. 3, also contained in the database. Displayable addresses, such as displayable addresses 318 of FIG. 3, are alias addresses that point to the same universal resource locator location as do corresponding confidential addresses. The database can be a lookup table, or other data structure capable of resolving a user input into a secondary data address. Confidential addresses are those universal resource locators for systems not really intended to be published to a wide or external audience for which a user may wish to use an alias address.

Process 400 then determines whether the universal resource locator input is identical to one of the displayable addresses (step 414). Responsive to finding that the universal resource locator input is identical to one of the displayable addresses (“yes” at step 414), process 400 recalls the corresponding one of the confidential addresses (step 416). Process 400 connects through a network to the confidential universal resource locator address (step 418). Process 400 retrieves information from the host at the confidential universal resource locator address, and displays to the user that information (step 420). However, instead of displaying routing and address information of the confidential address, process 400 displays the spurious routing and address information of the displayable address (step 422).

Returning now to step 414, responsive to finding that the universal resource locator input is not identical to one of the displayable addresses (“no” at step 414), process 400 connects through a network to the universal resource locator input address (step 424). Because universal resource locator input did not match one of the displayable addresses in the database, the universal resource locator input does not correspond to a confidential address. The universal resource locator input can therefore be resolved according to the address contained therein. Process 400 retrieves information from the host at the universal resource locator input address, and displays to the user that information (step 426). Process 400 displays the routing and address information of the universal resource locator input (step 428), with the process terminating thereafter.

In these illustrative examples, when the browser loads a universal resource locator address that does not match one of the displayable addresses in the database, the page to which the browser is resolved may still contain visible references to confidential addresses. If the resolved page contains a visible reference to a confidential address, process 400 may substitute the corresponding displayable address.

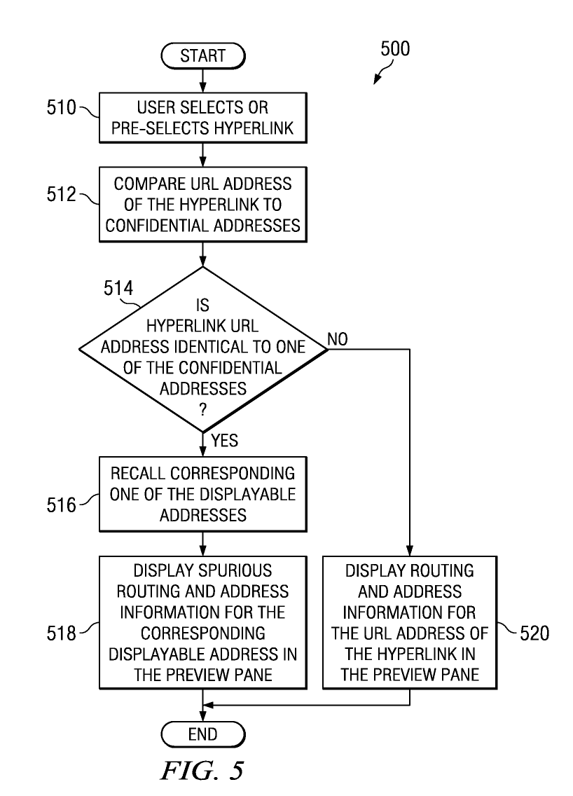

Referring now to FIG. 5, a flowchart illustrating processing steps is depicted according to illustrative embodiments. Process 500 is a software process, such as software process 310 of FIG. 3, executed on a data processing system, such as data processing system 310 of FIG. 3.

Process 500 displays a current browser page, which includes a hyperlink. A hyperlink is a reference or navigation element within a current browser page that points to another section of the current browser page, another document, or a specified section of another document. When the hyperlink is selected, the referred to information is retrieved to the user by process 500. The current browser page is provided with a preview pane. When the user selects or pre-selects a hyperlink, routing and address information of the hyperlink is displayed within the preview pane.

Process 500 begins by a user selecting or pre-selecting hyperlink 328 (step 510). Selecting a hyperlink means that the user has directed process 500 to resolve to the universal resource locator address of the hyperlink. Pre-selecting a hyperlink means that the user has performed any action that, while not directing process 500 to resolve the universal resource locator address of the hyperlink, will cause the universal resource locator address of the hyperlink to appear within the preview pane.

Responsive to detecting a selection or pre-selection of a hyperlink, process 500 compares the universal resource locator address of the hyperlink to confidential addresses (step 512). Confidential addresses, such as confidential addresses 316 of FIG. 3, are those universal resource locator s for systems not really intended to be published to a wide or external audience for which a user may wish to use an alias address. Confidential addresses are stored in a database, such as database 314 of FIG. 3, and correspond to displayable addresses, also contained in the database. Displayable addresses, such as displayable addresses 318 of FIG. 3, are alias addresses that point to the same universal resource locator location as do corresponding confidential addresses. The database can be a lookup table, or other data structure capable of resolving a user input into a secondary data address.

Process 500 then determines whether the hyperlink universal resource locator address is identical to one of the confidential addresses (step 514). Responsive to finding that the hyperlink universal resource locator address is identical to one of the confidential addresses (“yes” at step 514), process 500 recalls the corresponding one of the displayable addresses (step 516). Process 500 then displays the spurious routing and address information for the corresponding displayable address in the preview pane (step 518), with the process terminating thereafter.

Returning now to step 514, responsive to finding that the hyperlink universal resource locator address is not identical to one of the confidential addresses (“no” at step 514), process 500 displays the routing and address information for the hyperlink universal resource locator address in the preview pane (step 518), with the process terminating thereafter. Because the hyperlink universal resource locator address did not match one of the confidential addresses in the database, the hyperlink universal resource locator address does not correspond to a confidential address. The hyperlink universal resource locator address can therefore be resolved according to the address contained therein.

Thus, the presently described embodiments provide a computer implemented method, data processing system, and a computer program product for resolving uniform resource locator addresses. A first uniform resource locator address is received from a user input. The first uniform resource locator address is identified within a database list of uniform resource locator addresses. Each of the list of uniform resource locator addresses corresponds to a second uniform resource locator address contained in the database. Responsive to identifying the first uniform resource locator address within the list of uniform resource locator addresses, information for the corresponding second uniform resource locator address is displayed.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for resolving uniform resource locator addresses within a browser, the method comprising:
receiving in the browser a first uniform resource locator address from a user;
identifying the first uniform resource locator address within a list of uniform resource locator addresses, wherein the list of uniform resource locator addresses associates the first uniform resource locator address to a second uniform resource locator address; and
responsive to identifying the first uniform resource locator address within the list of uniform resource locator addresses, displaying information in the browser from the second uniform resource locator address

2. The computer implemented method of claim 1, wherein the step of receiving the first uniform resource locator address is selected from the list consisting of receiving a first hyperlink selection from an active document, receiving a second hyperlink selection from a history of previously active documents, receiving a third hyperlink selection from an e-mail, and receiving a manual entry of the first uniform resource locator address.

3. The computer implemented method of claim 1, wherein the step of receiving the first uniform resource locator address is selected from a user selection of a hyperlink and a user pre-selection of a hyperlink.

4. The computer implemented method of claim 1, wherein the step of identifying the first uniform resource locator address within the list of uniform resource locator addresses comprises:
identifying the first uniform resource locator address within a list of confidential uniform resource locator addresses.

5. The computer implemented method of claim 1, wherein the step of identifying the first uniform resource locator address within the list of uniform resource locator addresses comprises:
identifying the first uniform resource locator address within a list of displayable uniform resource locator addresses.

6. The computer implemented method of claim 1, wherein the step of displaying information from the second uniform resource locator address comprises:
retrieving the information from a host at the second uniform resource locator address, and displaying the information to a user.

7. The computer implemented method of claim 1, wherein the step of displaying information from the second uniform resource locator address comprises:
displaying routing and address information of the second uniform resource locator address in a preview pane.

8. A computer program product comprising:
a computer readable medium having computer usable program code for resolving uniform resource locator addresses within a browser, the computer program product comprising:
computer usable program code for receiving in the browser a first uniform resource locator address from a user;
computer usable program code for identifying the first uniform resource locator address within a list of uniform resource locator addresses, wherein the list of uniform resource locator addresses corresponds the first uniform resource locator address to a second uniform resource locator address; and
computer usable program code, responsive to identifying the first uniform resource locator address within the list of uniform resource locator addresses, for displaying information in the browser from a second uniform resource locator address.

9. The computer program product of claim 8, wherein the computer usable program code for receiving the first uniform resource locator address is selected from the list consisting of computer usable program code for receiving a first hyperlink selection from an active document, computer usable program code for receiving a second hyperlink selection from a history of previously active documents, computer usable program code for receiving a third hyperlink selection from an e-mail, and computer usable program code for receiving a manual entry of the first uniform resource locator address.

10. The computer program product of claim 8, wherein the computer usable program code for receiving the first uniform resource locator address is selected from computer usable program code for receiving a user selection of a hyperlink and computer usable program code for receiving a user pre-selection of a hyperlink.

11. The computer program product of claim 8, wherein the computer usable program code for identifying the first uniform resource locator address within the list of uniform resource locator addresses comprises:
computer usable program code for identifying the first uniform resource locator address within a list of confidential uniform resource locator addresses.

12. The computer program product of claim 8, wherein the computer usable program code for identifying the first uniform resource locator address within the list of uniform resource locator addresses comprises:
computer usable program code for identifying the first uniform resource locator address within a list of displayable uniform resource locator addresses.

13. The computer program product of claim 8, wherein the computer usable program code for displaying information from the second uniform resource locator address comprises:
computer usable program code for retrieving the information from a host at the second uniform resource locator address, and computer usable program code for displaying the information to a user.

14. The computer program product of claim 8, wherein the computer usable program code for displaying information from the second uniform resource locator address comprises:
computer usable program code for displaying in a preview pane routing and address information of the second uniform resource locator address.

15. A data processing system comprising:
a bus;
a communications unit connected to the bus;
a storage device connected to the bus, wherein the storage device includes computer usable program code; and
a processor unit connected to the bus, wherein the processor unit executes the computer usable program code to receive in a browser a first uniform resource locator address from a user, identify the first uniform resource locator address within a list of uniform resource locator addresses, wherein the list of uniform resource locator addresses corresponds the first uniform resource locator address to a second uniform resource locator address, and responsive to identifying the first uniform resource locator address within the list of uniform resource locator addresses, display in the browser information from a second uniform resource locator address.

16. The data processing system of claim 15, wherein the wherein the processor unit executing computer usable program code to receive the uniform resource locator address comprises the processor unit executing computer usable program code selected from the list consisting of: the processor unit executing computer usable program to receive a first hyperlink selection from an active document, the processor unit executing computer usable program to receive a second hyperlink selection from a history of previously active documents, the processor unit executing computer usable program to receive a third hyperlink selection from an e-mail, and the processor unit executing computer usable program to receive a manual entry of the first uniform resource locator address.

17. The data processing system of claim 15, wherein the the processor unit executing computer usable program code to receive the first uniform resource locator address is selected from a user selection of a hyperlink and a user pre-selection of a hyperlink.

18. The data processing system of claim 15, wherein the the processor unit executing computer usable program code to identify the first uniform resource locator address within the list of uniform resource locator addresses comprises:
the processor unit executing computer usable program code to identify the first uniform resource locator address within a list of confidential uniform resource locator addresses.

19. The data processing system of claim 15, wherein the the processor unit executing computer usable program code to identify the first uniform resource locator address within the list of uniform resource locator addresses comprises:
the processor unit executing computer usable program code to identify the first uniform resource locator address within a list of displayable uniform resource locator addresses.

20. The data processing system of claim 15, wherein the the processor unit executing computer usable program code to display information from the second uniform resource locator address comprises either the processor unit executing computer usable program code to retrieve the information from a host at the second uniform resource locator address, and to display the information to a user, or the processor unit executing computer usable program code to display routing and address information of the second uniform resource locator address in a preview pane.
